(19) United States
(12) Patent Application Publication
(10) Pub. No.: US 2009/0196977 A1
(43) Pub. Date: Aug. 6, 2009

(54) HEALTH FOOD

(75) Inventor: Teruyuki NANBU, Hakata-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASKA CORPORATION Co., Ltd., Hakata-ku (JP)

(21) Appl. No.: 12/140,759

(22) Filed: Jun. 17, 2008

(30) Foreign Application Priority Data
Feb. 6, 2008 (JP) 2008-026426

(51) Int. Cl. A23L 1/30

(52) U.S. Cl. 426/648

(57) ABSTRACT

The invention provides a health food which is protected from degradation caused by oxidation over a long period of time, even though the food contains no antioxidant.

According to the invention, a health food active ingredient is clathrated by a cyclic oligosaccharide. The resultant health food can be protected from oxidation and degradation over a long period of time without use of an antioxidant. The cyclic oligosaccharide is preferably β-cyclodextrin or γ-cyclodextrin.

### BACKGROUND OF THE INVENTION

1. Field of the Invention

The present invention relates to a health food, and more particularly to a health food which is protected from degradation caused by oxidation over a long period of time.

2. Background Art

Health foods are suitable for nutritional supplements or healthcare, and contain a nutrient or a similar ingredient in a large amount as compared with common foods. In general, food and beverage products, including such health foods, contain an appropriate amount of an antioxidant, in order to prevent degradation of ingredients of the products, which would otherwise occur due to oxidation during production or storage of the products.

For example, Japanese Patent Application Laid-Open (kokai) No. 57-115147 discloses a method for preventing browning of sugar by use of caffeic acid, ferulic acid, or chlorogenic acid. Also, Japanese Patent Publication (kokoku) No. 03-7232 and Japanese Patent Application Laid-Open (kokai) No. 03-200781 disclose an antioxidant used for preventing degradation of foods, etc. due to oxidation, which contains, as an active ingredient, a small amount of proanthocyanidin, which is extracted from plants (e.g., grape pomace or grape seeds).

However, such an antioxidant is not satisfactory in terms of safety. Therefore, demand has arisen for a technique for preventing oxidation-induced degradation of a health food without use of an antioxidant.

### SUMMARY OF THE INVENTION

In view of the foregoing, an object of the present invention is to provide a health food which is protected from degradation caused by oxidation over a long period of time, even though the food contains no antioxidant.

In order to achieve the aforementioned object, the present inventors have conducted extensive studies on a technique for preventing oxidation-induced degradation of a health food without use of an antioxidant, and have found that when a health food active ingredient is clathrated by a cyclic oligosaccharide, without use of an antioxidant, the resultant health food can be protected from oxidation and degradation over a long period of time. The present invention has been accomplished on the basis of this finding.

Accordingly, the present invention provides a health food containing a health food active ingredient and a cyclic oligosaccharide, wherein the active ingredient is clathrated by the cyclic oligosaccharide.

The health food of the present invention is protected from degradation caused by oxidation over a long period of time, although it contains no antioxidant.

### DETAILED DESCRIPTION OF PREFERRED EMBODIMENTS

In the health food of the present invention, a cyclic oligosaccharide (e.g., cyclodextrin), which has an intramolecular cavity, captures a health food active ingredient in the cavity, and protects the active ingredient from oxidation-induced degradation over a long period of time. A cyclic oligosaccharide is a substance whose safety has been already confirmed.

The cyclic oligosaccharide employed in the present invention may be α-cyclodextrin, β-cyclodextrin, or γ-cyclodextrin. A mixture of these cyclodextrins may be employed. Particularly, β-cyclodextrin or γ-cyclodextrin is preferably employed.

The health food of the present invention may be in the form of powder produced by bringing a health food active ingredient or a similar ingredient into contact with a cyclic oligosaccharide, followed by drying. Specifically, the health food may be produced through the following procedure: a health food active ingredient and a cyclic oligosaccharide are mixed by means of a wet granulator, and the particle size of the resultant mixture is regulated by means of a particle size regulator, followed by drying by means of a fluidized-bed dryer.

In the health food of the present invention, the active ingredient clathrated by the cyclic oligosaccharide may be, for example, a vitamin such as vitamin E, a coenzyme such as coenzyme Q10, collagen, elastin, placenta extract, ceramide, or sodium hyaluronate.

### EXAMPLES

The present invention will next be described by way of examples, which should not be construed as limiting the invention thereto.

### Example 1

Coenzyme Q10 (20 parts by weight), β-cyclodextrin (80 parts by weight), a solvent mixture of ethanol (95 wt. %) and distilled water (5 wt. %) were placed for mixing in a wet mixer/granulator having a large blade (rotation speed: 200 rpm) and a small blade (rotation speed: 3,000 rpm). The particle size of the resultant mixture was regulated by means of a particle size regulation, followed by drying by means of a fluidized-bed dryer, to thereby yield a health food containing coenzyme-Q10 clathrated by β-cyclodextrin.

### Example 2

The procedure of Example 1 was repeated, except that coenzyme Q10 (20 parts by weight) was substituted by natural vitamin E (20 parts by weight), to thereby yield a health food containing natural vitamin E clathrated by β-cyclodextrin.

### Comparative Example 1

The procedure of Example 1 was repeated, except that β-cyclodextrin (80 parts by weight) was substituted by crystalline cellulose (80 parts by weight), to thereby yield a health food.

### Comparative Example 2

The procedure of Example 2 was repeated, except that β-cyclodextrin (80 parts by weight) was substituted by crystalline cellulose (80 parts by weight), to thereby yield a health food.

The health foods produced in Examples 1 and 2 and Comparative Examples 1 and 2 were stored at ambient temperature while being exposed to air. As a result, the health foods of Comparative Examples 1 and 2 generated a mal-odor after the elapse of one month. In contrast, the health foods of Examples 1 and 2 generated no a mal-odor even after the elapse of six months.

These data indicate that when an active ingredient is clathrated by a cyclic oligosaccharide, the resultant health food exhibits stability and is protected from degradation by oxidation over a long period of time.

As described hereinabove, when a health food active ingredient is clathrated by a cyclic oligosaccharide, without use of an antioxidant, the resultant health food can be protected from degradation caused by oxidation over a long period of time.

What is claimed is:

1. A health food containing a health food active ingredient and a cyclic oligosaccharide, wherein the active ingredient is clathrated by the cyclic oligosaccharide.

2. A health food as described in claim 1, wherein the cyclic oligosaccharide is β-cyclodextrin or γ-cyclodextrin.
